(19) United States
(12) Patent Application Publication
(10) Pub. No.: US 2025/0049053 A1
(43) Pub. Date: Feb. 13, 2025

(54) FEATHER CAP

(71) Applicant: LTA Distributing, LLC, Millsboro, DE (US)

(72) Inventor: Donald Andrew McCoy, JR., Millsboro, DE (US)

(21) Appl. No.: 18/796,568

(22) Filed: Aug. 7, 2024

Related U.S. Application Data
(60) Provisional application No. 63/531,313, filed on Aug. 7, 2023.

(51) Int. Cl. A22C 21/02

(52) U.S. Cl. CPC A22C 21/022

(57) ABSTRACT

A poultry defeathering device, comprising a feather cap having a first opening configured to be coupled to a hub, a finger plate having a plurality of second openings, each of the second openings configured to be coupled to a respective rubber finger, wherein bases of respective rubber fingers determine a distance between the feather cap and the finger plate.

### PRIORITY INFORMATION

This application claims the benefit of U.S. Provisional Patent Application No. 63/531,313 filed on Aug. 7, 2023, which is hereby incorporated by reference in its entirety.

### FIELD OF THE INVENTION

The embodiments of the present invention generally relate to poultry defeathering devices and more particularly to devices that provide a more efficient way to replace rubber picking fingers inside the defeathering devices.

### DISCUSSION OF THE RELATED ART

As discussed in U.S. Pat. No. 10,785,988, millions of tons of poultry are raised, processed, and brought to market yearly throughout the world. In 2016 for example, and in the United States alone, over 8.78 billion broiler chickens were produced and over 244 million turkeys were produced with a value in excess of $32 billion dollars. Poultry is processed in an efficient manner by shackling, stunning, bleeding, scalding, picking, eviscerating, washing, chilling, carving, and deboning.

Machines replaced workers plucking the feathers of poultry in poultry plants decades ago. Modern picking machines generally include a plurality of discs or drums onto which fingers are secured. Several discs are positioned along the sides of a path traversed by a chain/shackle carrying the poultry through the machine. The discs are rapidly rotated, ensuring that the fingers contact as much of the outer surface of each bird as possible. These fingers then “pick” the feathers off each poultry carcass as it passes through the machine via chain/shackle. Unfortunately, the fingers often crack, break or wear out at a significant rate due to the friction involved in the de-feathering process. This makes it necessary to replace thousands of fingers each month for each processing line.

A plurality of fingers is mounted to each disc or drum. Fingers are generally shaped having a larger base, a tapered body and a smaller diameter tip end. The tapered body is often ribbed, and most fingers include a groove located next to the base. Each disc has a plurality of openings large enough for the body of each finger to fit through, but small enough to abut the base diameter. Each finger is secured by pulling the finger through a hole and seating the hole within the finger groove. A typical picking line will include four defeathering machines. Each machine may have 640 or more fingers making each line use in excess of 2500 fingers to defeather poultry and each machine utilizes water sprays to continually wash feathers off both the fingers and the poultry as its processed.

In a typical configuration, there are 64 units (e.g., disks) per machine. The individual fingers get pulled through the holes and locked into a multi (e.g., 6, 8, 10) hole finger plate (e.g., disk), the industry standard plate in the market. Each multi hole finger plate is bolted to a respective drive shaft or hub of the defeathering machine. The machine typically includes 64 hubs (components that have a belt driven pulley that goes on the drive side of the hub and an extended shaft that comes out the front) which the multi hole finger plate bolts to.

Various plucking fingers have been used for decades. In an example configuration, the holes of the multi hole finger plate are 18 mm in diameter. A rubber picking finger is about 23.50 mm at its widest point before it drops off into a 19.30 mm slot that locks the finger in place. Behind this groove is the head of the finger measuring almost 29 mm wide and 11 mm thick representing something like a bolt head. When replacing a finger, the user has to pull very hard to get the finger into the slot. In some instances, soap or other lubricants are used to lube up the finger(s) before pulling. To remove these fingers a person uses a knife to cut the finger into and around the slotted area to remove the finger.

Replacement of fingers in previous plucking machines is both difficult and time consuming. In some configurations, each finger must first be cut off by hand. This process is labor intensive and dangerous as it involves the use of a blade in a tight, awkward environment. A replacement finger is then inserted into the vacant opening and pulled, often with some form of plier and significant force, to seat the opening within a groove of the finger. Plucking machines utilizing a plurality of feather stripping fingers continue to be the favored method for defeathering poultry. Unfortunately, the current devices and designs continue to be lacking in efficient finger replacement.

U.S. Pat. No. 5,711,703 to Peretz discloses an apparatus for removing a rubber finger from a disc or rotational drum. The finger shank is inserted into the apparatus where a blade cuts the finger close to the annular recess. The base of the finger may then be simply pushed through the backside of the disc. The Peretz patent does not address the inherent difficulties of inserting new fingers into the disc, but rather is concerned with the removal of worn fingers.

U.S. Pat. No. 7,121,941 to Turner discloses a support disc and rubber finger structure that allows an operator to easily insert and remove plucking fingers from the support disc without the application of excessive force. In order to prevent unwanted movement of the finger within the hole, and possible dislodgement therefrom, a backing plate is provided to abut the rear of the support plate and hold the finger securely.

U.S. Pat. No. 10,785,988 to Batty et al. discloses a hub drive shaft that is secured to a finger plate and a compression plate. The finger plate includes a central aperture and an annular abutment ring operationally associated with the central aperture. An oversized base of each finger is compressed between the compression plate and the finger plate and a mounting bolt is secured on the finger plate within a threaded hole of the hub drive shaft.

As identified by the inventor, there is a continued need for a more efficient and less dangerous device to facilitate the removal and replacement of fingers within a defeathering device.

### SUMMARY OF THE INVENTION

Accordingly, the embodiments of the present invention are directed to a device that substantially obviates one or more problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the feather cap assembly is a poultry defeathering device, comprising a feather cap having a first opening configured to be coupled to a hub, a finger plate having a plurality of second openings, each of the second openings configured to be coupled to a respective rubber finger, wherein bases of respective rubber fingers determine a distance between the feather cap and the finger plate.

In an example embodiment, a poultry defeathering device comprises a feather cap having a drive shaft opening configured to be coupled to a drive shaft of a hub, and a finger plate having a plurality of finger openings, each of the finger openings configured to be coupled to a respective rubber finger of a plurality of rubber fingers.

In the various embodiments, bases of respective rubber fingers determine a distance between the feather cap and the finger plate. In the various embodiments, In the various embodiments, the feather cap slides over at least a portion of the hub. In the various embodiments, the drive shaft of the hub protrudes through the feather cap. In the various embodiments, the drive shaft of the hub does not protrude entirely through the finger plate. In the various embodiments, the drive shaft of the hub is flush with an outer surface of the finger plate. In the various embodiments, the finger plate is bolted to the drive shaft. In the various embodiments, each of the plurality of rubber fingers is held in place by compression between the feather cap and the finger plate. In the various embodiments, the feather cap comprises plastic. In the various embodiments, the feather cap has a thickness 5 mm or greater. In the various embodiments, the feather cap has a thickness between 6 mm and 9 mm. In the various embodiments, the drive shaft opening is square or triangular. In the various embodiments, the drive shaft opening is circular. In the various embodiments, In the various embodiments, an adapter is used to physically couple the feather cap and the drive shaft.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a perspective view of a feather cap assembly, showing a new design according to an embodiment.

FIG. 2 is a front elevation view thereof according to the embodiment.

FIG. 3 is a rear elevation view thereof according to the embodiment.

FIG. 4 is a left elevation view thereof according to the embodiment.

FIG. 5 is a right elevation view thereof according to the embodiment.

FIG. 6 is a top plan view thereof according to the embodiment.

FIG. 7 is a bottom plan view thereof according to the embodiment.

FIG. 8 is a contextual view thereof according to the embodiment.

### DETAILED DESCRIPTION OF THE INVENTION

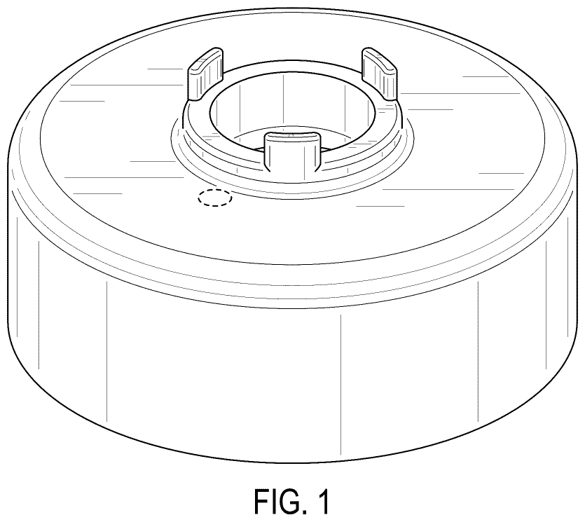

Reference will now be made in detail to the embodiments of the present invention, examples of which are illustrated in the accompanying drawings. FIGS. 1-8 illustrate example embodiments of the present invention.

The embodiments of the present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each may also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

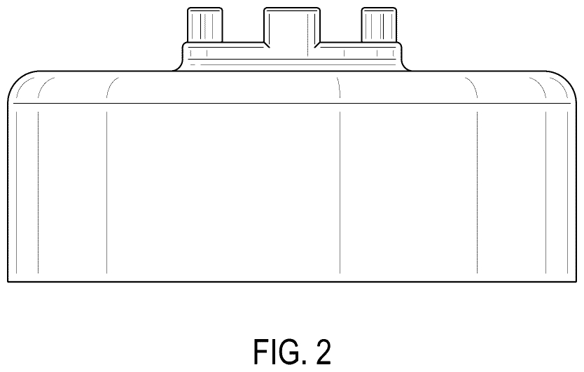

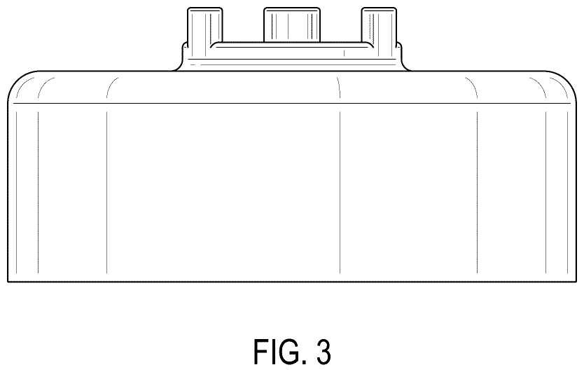

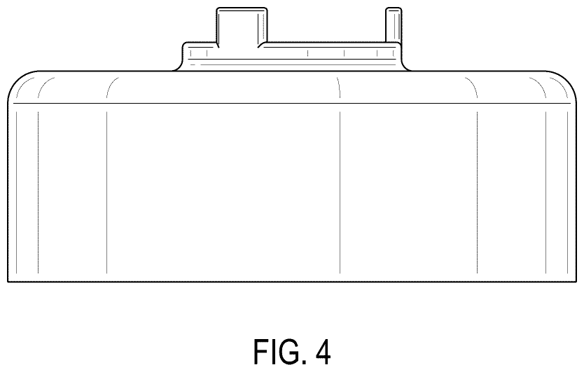

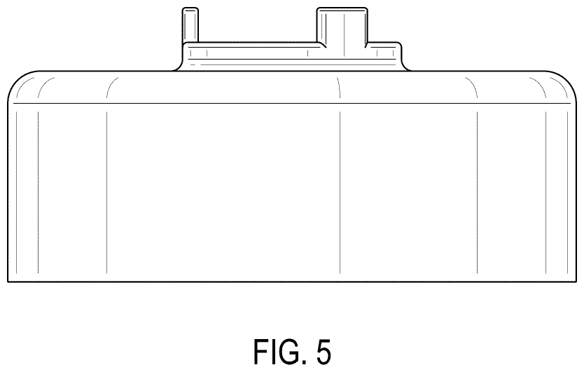

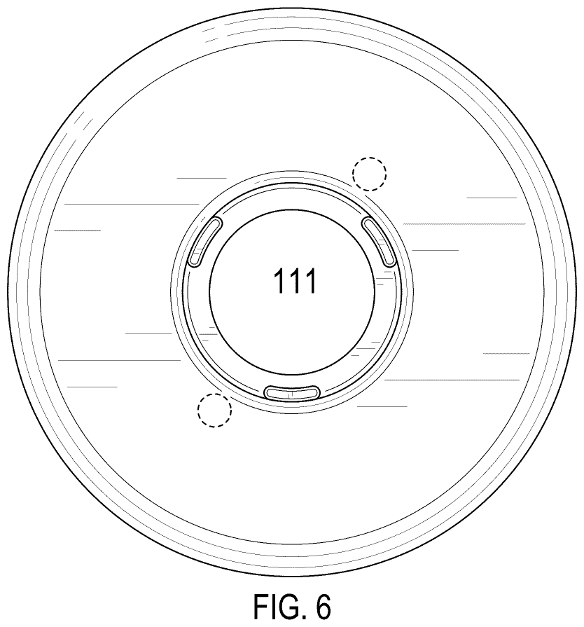

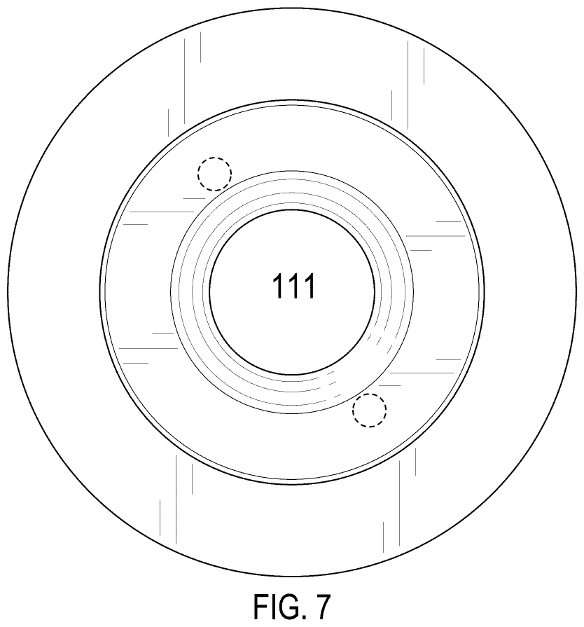

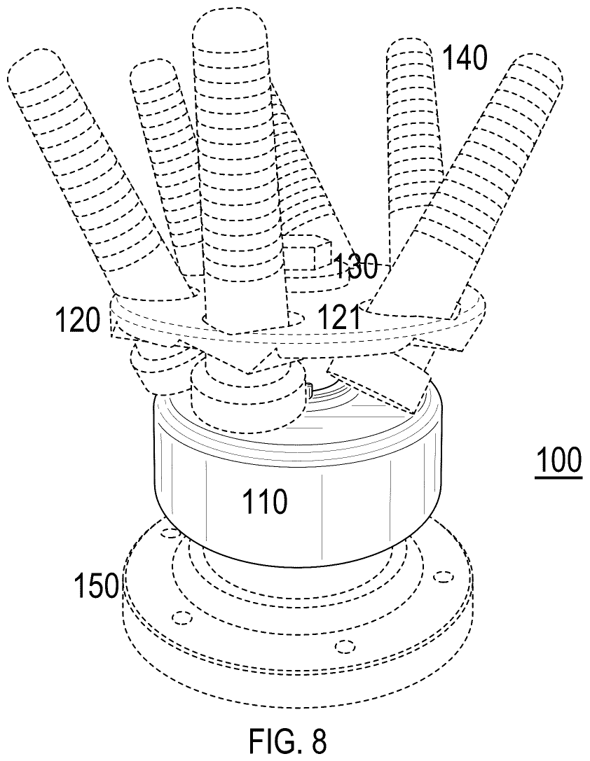

FIG. 1 is a perspective view of a feather cap assembly, showing a new design according to an embodiment. FIG. 2 is a front elevation view thereof according to the embodiment. FIG. 3 is a rear elevation view thereof according to the embodiment. FIG. 4 is a left elevation view thereof according to the embodiment. FIG. 5 is a right elevation view thereof according to the embodiment. FIG. 6 is a top plan view thereof according to the embodiment. FIG. 7 is a bottom plan view thereof according to the embodiment. FIG. 8 is a contextual view thereof according to the embodiment.

As illustrated in FIGS. 1-8, the various embodiments include an assembly 100 that includes a feather cap 110 and a finger plate 120 that are operatively and physically joined, connected, and/or coupled by bolt or bolting mechanism 130. Feather cap 110 has a quasi-cup or quasi-cylindrical structure having a smaller drive-shaft opening 111 at one distal end and a larger hub opening to receive hub 150 at an opposite distal end. Feather cap 110 slides over at least a portion of hub 150. Optionally, in some embodiments, feather cap 110 may be coupled to hub 150 using one or more screws/bolds disposed via respective through holes in feather cap 110.

Feather cap 110 includes a first opening or drive shaft opening 111 configured to physically join feather cap 110 to a drive shaft of a hub 150. Drive shaft opening 111 may take on a variety of shapes or structures (e.g., circular, square, triangular) to physically join feather cap 110 with a variety of commercially available drive shafts of commercially available hubs. In some configurations, one or more adapters may be used to physically join feather cap 110 with a variety of commercially available drive shafts. For example, one end of an adapter may be configured to physically join with the drive shaft, and another end of the adapter may be configured to physically join with the drive shaft opening 111 and/or opening of the finger plate (e.g., triangular, or square). In this way, the various embodiments are intended to be universally applicable and not limited to any particular drive shaft or hub assembly.

Finger plate 120 includes a plurality of second openings or finger openings 121. Each of finger openings 121 is configured to receive or to be coupled to a respective finger 140. Finger plate 120 includes a center opening that enables access to the drive shaft received through drive shaft opening 111. For example, the center opening enables access to bolt/unbolt mechanism 130 for the drive shaft received through drive shaft opening 111. Although the drive shaft of hub 150 protrudes through feather cap 110 to be received at the center opening of finger plate 120, the drive shaft of hub 150 may not protrude entirely through the finger plate. In some instances, the drive shaft of hub 150 may be flush with an upper or outer surface fingerplate 120.

Bolt 130 and optional washer are configured to physically join, connect, and/or couple feather cap 110 and finger plate 120 via bases of rubber fingers 140. In a bolted position, bases of fingers 140 are secured (e.g., compressed) between feather cap 110 and finger plate 120 of assembly 100.

The respective locations of finger openings 121 are spaced so as to evenly apply pressure/compression to the respective bases of fingers 140. As a result, movement and wear of fingers 140 is reduced. Excessive movement and wear of fingers 140 is a known problem of current defeathering devices.

The components of assembly 100 may be comprised of a variety of materials such as stainless steel, mild steel, aluminum, metal alloys, durable plastics, combinations thereof, and the like. The feather cap 110 may be comprised of a variety of durable and/or lightweight plastics. In the various configurations, the components are configured for durability. For example, feather cap 110 may have a thickness of 5 mm or greater than 5 mm (preferably, a range between 6 mm to 9 mm).

The feather cap is a plastic device designed to keep water and feathers out of the bearing and seal area of the hub. By increasing the thickness of the feather cap, it also can be used as a back plate for compressing rubber fingers in place. Typical finger plates have 19 mm holes. By using the feather cap of the embodiments, the finger openings can have an increased diameter of 24 mm, enabling easy replacement of rubber fingers.

The embodiments of the invention may use a variety of commercially available fingers. In this aspect, the embodiments are not limited to particular fingers of finger manufacturers. With the exception of size, fingers are generally interchangeable with one another.

List of components used herein: assembly 100, feather cap 110, drive shaft opening 111, finger plate 120, finger openings 121, center, bolt 130, fingers 140, and hub 150.

It will be apparent to those skilled in the art that various modifications and variations may be made in the feather cap of the present invention without departing from the spirit or scope of the invention. Thus, it is intended that the present invention cover the modifications and variations of this invention provided they come within the scope of the appended claims and their equivalents.

What is claimed is:

1. A poultry defeathering device, comprising:
a feather cap having a drive shaft opening configured to be coupled to a drive shaft of a hub, and
a finger plate having a plurality of finger openings, each of the finger openings configured to be coupled to a respective rubber finger of a plurality of rubber fingers.

2. The poultry defeathering device of claim 1, wherein bases of respective rubber fingers determine a distance between the feather cap and the finger plate.

3. The poultry defeathering device of claim 1, wherein the feather cap slides over at least a portion of the hub.

4. The poultry defeathering device of claim 1, wherein the drive shaft of the hub protrudes through the feather cap.

5. The poultry defeathering device of claim 1, wherein the drive shaft of the hub does not protrude entirely through the finger plate.

6. The poultry defeathering device of claim 1, wherein the drive shaft of the hub is flush with an outer surface of the finger plate.

7. The poultry defeathering device of claim 1, wherein the finger plate is bolted to the drive shaft.

8. The poultry defeathering device of claim 1, wherein each of the plurality of rubber fingers is held in place by compression between the feather cap and the finger plate.

9. The poultry defeathering device of claim 1, wherein the feather cap comprises plastic.

10. The poultry defeathering device of claim 1, wherein the feather cap has a thickness 5 mm or greater.

11. The poultry defeathering device of claim 1, wherein the feather cap has a thickness between 6 mm and 9 mm.

12. The poultry defeathering device of claim 1, wherein the drive shaft opening is square or triangular.

13. The poultry defeathering device of claim 1, wherein the drive shaft opening is circular.

14. The poultry defeathering device of claim 1, wherein an adapter is used to physically couple the feather cap and the drive shaft.
